(19) United States
(12) Patent Application Publication
(10) Pub. No.: US 2014/0222574 A1
(43) Pub. Date: Aug. 7, 2014

(54) PRESENCE DETECTION USING BLUETOOTH AND HYBRID-MODE TRANSMITTERS

(71) Applicant: Shopkick, Inc., Redwood City, CA (US)

(72) Inventors: Aaron T. Emigh, Incline Village, NV (US); Vivek Shrivastava, San Francisco, CA (US); Steven Stanek, Fremont, CA (US)

(21) Appl. No.: 14/172,849

(22) Filed: Feb. 4, 2014

Related U.S. Application Data
(60) Provisional application No. 61/760,320, filed on Feb. 4, 2013.

(51) Int. Cl. H04W 4/00; G06Q 30/02; H04W 4/04; H04W 4/06

(52) U.S. Cl. CPC H04W 4/008; H04W 4/06; G06Q 30/0261; H04W 4/04
USPC 705/14.58; 455/3.06

(57) ABSTRACT

Presence detection using Bluetooth and hybrid-mode transmitters is disclosed. In some embodiments, a transmitter is configured to broadcast a secure identifier comprising a venue identifier using Bluetooth Low Energy (BTLE) and/or an ultrasonic audio channel. The secure identifier broadcast by the transmitter is captured by a handset and decoded to infer presence of the handset at a venue identified by the venue identifier.

### CROSS REFERENCE TO OTHER APPLICATIONS

This application claims priority to U.S. Provisional Patent Application No. 61/760,320 entitled PRESENCE DETECTION USING BLUETOOTH AND HYBRID-MODE TRANSMITTERS filed Feb. 4, 2013 which is incorporated herein by reference for all purposes.

### BACKGROUND OF THE INVENTION

Current technologies for detecting presence suffer from many limitations, including high costs of hardware and/or installation (e.g., for wifi triangulation) and reliance on handset audio channels that may vary (e.g., for ultrasonic audio based technologies).

### BRIEF DESCRIPTION OF THE DRAWINGS

Various embodiments of the invention are disclosed in the following detailed description and the accompanying drawings.

FIG. 1A is a high level block diagram illustrating an embodiment of components that may be employed for presence detection.

FIG. 1B is a high level block diagram illustrating an embodiment of a transmitter.

FIG. 2 is a flow chart illustrating an embodiment of a process for broadcasting a secure identifier.

FIGS. 3A-3B are flow charts illustrating embodiments of processes for validating a received secure identifier.

FIG. 4 comprises flow charts illustrating embodiments of processes associated with updating the firmware on a transmitter.

FIG. 5 comprises flow charts illustrating embodiments of processes associated with updating the transmitter identifier of a transmitter.

### DETAILED DESCRIPTION

The invention can be implemented in numerous ways, including as a process, an apparatus, a system, a composition of matter, and/or a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below. The invention is described in connection with such embodiments, but the invention is not limited to any embodiment. The scope of the invention is not limited by these embodiments, and the invention encompasses numerous alternatives, modifications, and equivalents. Numerous specific details are set forth in the following description in order to provide a thorough understanding of the invention. These details are provided for the purpose of example, and the invention may be practiced without some or all of these specific details. For the purpose of clarity, technical material that is known in the technical fields related to the invention has not been described in detail so that the invention is not unnecessarily obscured.

Presence detection, e.g., at a venue such as a store, can be used for a variety of purposes, such as presenting content relevant to the venue at which presence is detected (for example content that a user has indicated as favorite content or content that is recommended by a recommendation system using prior user behavior and/or externally available data such as Facebook Open Graph data as inputs) or issuing a reward in exchange for presence at the venue. Some benefits of presence detection are delineated in prior U.S. patent application Ser. No. 13/197,763, entitled METHOD AND SYSTEM FOR PRESENCE DETECTION, filed Aug. 3, 2011, which is herein incorporated by reference in its entirety for all purposes, as if set forth in full herein. All applications enumerated therein may be used with respect to presence detection techniques as described herein, and its description of an ultrasonic-based transmitter can be taken as a description of possible operation of the audio-based transmitter component(s) described herein.

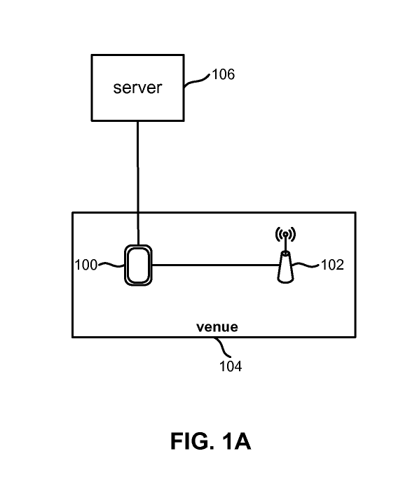

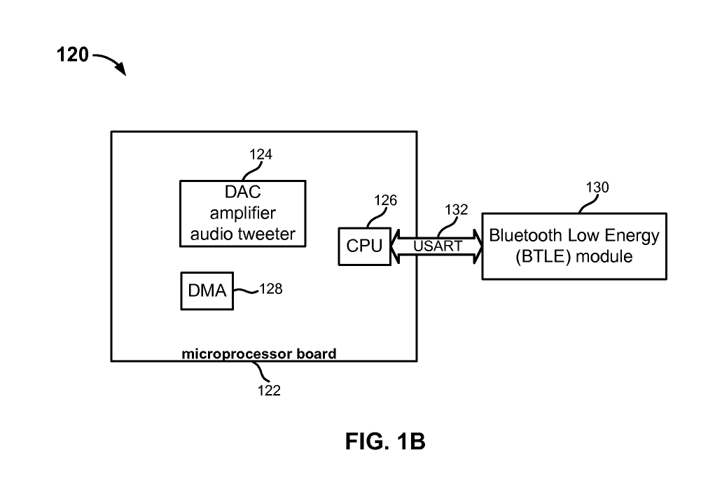

FIG. 1A is a high level block diagram illustrating an embodiment of components that may be employed for presence detection. In the given example, handset 100 detects presence of transmitter 102 on the premises of venue 104 and reacts accordingly, e.g., by communicating with server 106 via a wireless network. Transmitter 102 may be configured for one or more of the following functionalities: to broadcast store and department identifiers detectable by mobile users using both audio and Bluetooth technologies; to prevent replay attacks and rogue transmitters from cheating; to passively detect when a user enters a store and notify the user of any relevant information, including, but not limited to, notifying the user to open an application and redeem existing rewards (e.g., points); and to update the store and department identifiers broadcast by the transmitter remotely and securely from a mobile handset.

The term “handset” as used herein may refer to any mobile computing device, such as a smartphone, a tablet, etc. A typical handset, such as handset 100 of FIG. 1A, includes a microprocessor, a memory coupled to the microprocessor providing both code that the microprocessor executes and data under the control of the microprocessor, a display (e.g., a touch-sensitive display) through which the user may view and interact with user interface elements, a Bluetooth transceiver, a microphone, a cellular and/or wifi transceiver, and various other components. For the purposes of this exposition, when it is said that a handset performs a technique, this should be taken to mean that the microprocessor performs operations according to the code stored in its associated memory and interacts with other components within the handset, as necessary, to perform said technique.

In some embodiments, a transmitter, such as transmitter 102 of FIG. 1A, incorporates two technologies: a Bluetooth Low Energy (BTLE) module and an on-board audio module (e.g., comprising a DAC and tweeter) that allow the transmitter to broadcast identifiers in two media. Bluetooth and BTLE as used herein, as well as many Bluetooth specific terms known to those skilled in the art, are as set forth in the Specification of the Bluetooth System, version 4.0, dated Jun. 30, 2010, available online from the Bluetooth Special Interest Group at https://www.bluetooth.org/Technical/Specifications/adopted.htm and/or https://www.bluetooth.org/docman/handlers/downloaddoc.ashx?doc_id=229737, which are herein incorporated by reference in their entirety for all purposes, as if set forth in full herein.

FIG. 1B is a high level block diagram illustrating an embodiment of a transmitter. For example, transmitter 120 of FIG. 1B comprises transmitter 102 of FIG. 1A. As depicted, transmitter 120 includes a microprocessor board 122. Note that use of the terminology “board” does not imply that a separate physical board is needed; all components (or all components except the tweeter) may be included in a single physical board. Microprocessor board 122 comprises an onboard digital-to-analog converter (DAC) and broadcasts store and/or department identifier(s) through an amplifier connected to a tweeter as depicted via block 124. As used herein, the term “tweeter” refers to a transducer capable of reproducing sound in an appropriate spectrum, e.g., ultrasonic frequencies relevant to an ultrasonic transmitter. As depicted, microprocessor board 122 further includes central processing unit (CPU) 126 and direct memory access (DMA) 128. In some embodiments, the DAC may be integrated into the CPU. Transmitter 120 further includes a Bluetooth Low Energy (BTLE) module 130. In some embodiments, BTLE module 130 comprises a standalone BTLE module that runs a minimalist stack and talks to microprocessor board 122 over universal synchronous/asynchronous receiver/transmitter (USART) link 132.

In some embodiments, a transmitter (e.g., transmitter 102 of FIG. 1A or transmitter 120 of FIG. 1B) broadcasts store and/or department identifier(s) using both audio and Bluetooth channels. In some embodiments, for audio, an identifier is encoded using ultrasonic frequencies and broadcast using a tweeter. In some embodiments, for Bluetooth, an identifier is embedded in the advertisement parameters of a Bluetooth beacon and broadcast as a service that can be detected by mobile handsets using passive scanning of Bluetooth channels.

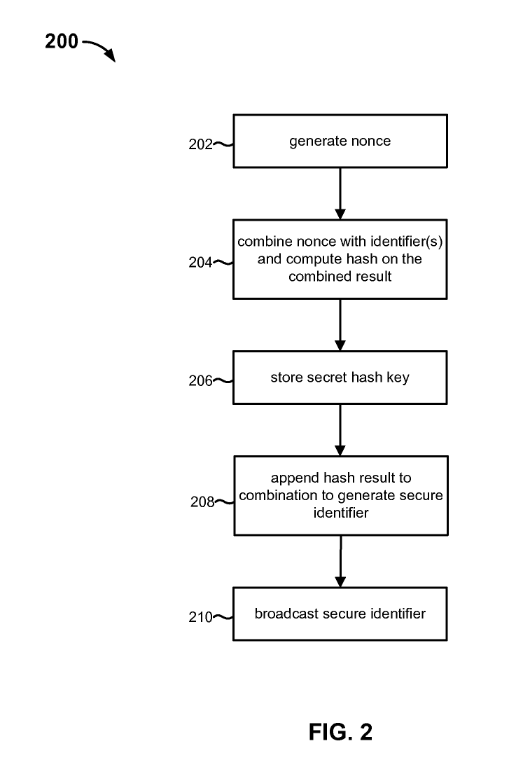

FIG. 2 is a flow chart illustrating an embodiment of a process for broadcasting a secure identifier or code. In some embodiments, code rotation is employed for preventing fraud. Process 200 specifically employs a nonce and hashing mechanism for preventing replay attacks. At step 202, a nonce is generated. A nonce, which is never repeated, may be periodically generated by a transmitter (e.g., transmitter 102 of FIG. 1A or transmitter 120 of FIG. 1B) using any appropriate technique. For example, in some embodiments, a hash of a current timestamp from the microprocessor or Bluetooth clock is used to generate the nonce. In another example, a simple monotonically increasing sequence that is updated periodically is used to generate the nonce. In such cases, the periodicity of the increments may be selected appropriately and/or changed dynamically. An example of an increment is ten minutes.

At step 204, the nonce generated at step 202 is combined with store and/or department identifier(s) that need to be broadcasted, and an irreversible hash is computed on the combined result. The term “hash” is used informally for the purpose of this discussion and includes a keyed hash with a secret key in addition to any explicitly mentioned content being hashed. The hash may comprise any cryptographic hash function known to those skilled in the art, such as SHA-1, MD5, etc. An example of what may be meant as a “hash” is an HMAC using SHA-1. HMAC is described in the Internet Engineering Task Force (IETF) RFC 2104, available online from the IETF at http://tools.ietf.org/html/rfc2104, which is included herein by reference for all purposes, as if set forth herein in its entirety.

At step 206, a secret hash key is stored. For example, the secret hash key is burned into a memory, such as within transmitter microprocessor code, and is not exposed to any external parties.

At step 208, the hash result is appended at the end of the combination to generate a secure identifier for broadcasting according to the following formula:

secure identifier=(nonce+store identifier+hash(nonce+store identifier))

As used herein, the store identifier may include a department identifier, either as a separate component of the store identifier, or as a single identifier that is associated, for example in a database, with separate store and department identifiers. In one example of a generated secure identifier, four bytes are used for the nonce, eight bytes are used for the store identifier, and four bytes are used for the hash.

At step 210, the secure identifier generated at step 208 is broadcasted. In some embodiments, a broadcast is preceded by appropriately configuring BTLE module 130 to update service parameters, e.g., via USART 132. In some embodiments, the Bluetooth service identifier is set to a prescribed (e.g., the shopkick) service identifier. The service identifier is a constant (e.g., 128 bit) universally unique identifier (UUID) to allow passive scanning under a handset operating system, such as iOS or Android. In such cases, the secure identifier may be broadcasted as service parameters for the constant (shopkick) service. Thus, step 210 may include broadcasting the constant service UUID and the secure identifier as the service parameters via Bluetooth beacons and optionally modulating it (or a modified version, such as the store identifier instead of the service identifier, or a version without the department code) using ultrasonic frequencies.

A secure identifier broadcast by a transmitter (e.g., transmitter 102 of FIG. 1A or transmitter 120 of FIG. 1B) may be captured by mobile handsets of users through an audio channel by capturing sound on a microphone, by actively scanning Bluetooth advertisements, and/or by utilizing features of a handset operating system to passively scan. For example, a list of service UUIDs to listen for may be provided, and a notification may be received when any identifier from the list is detected.

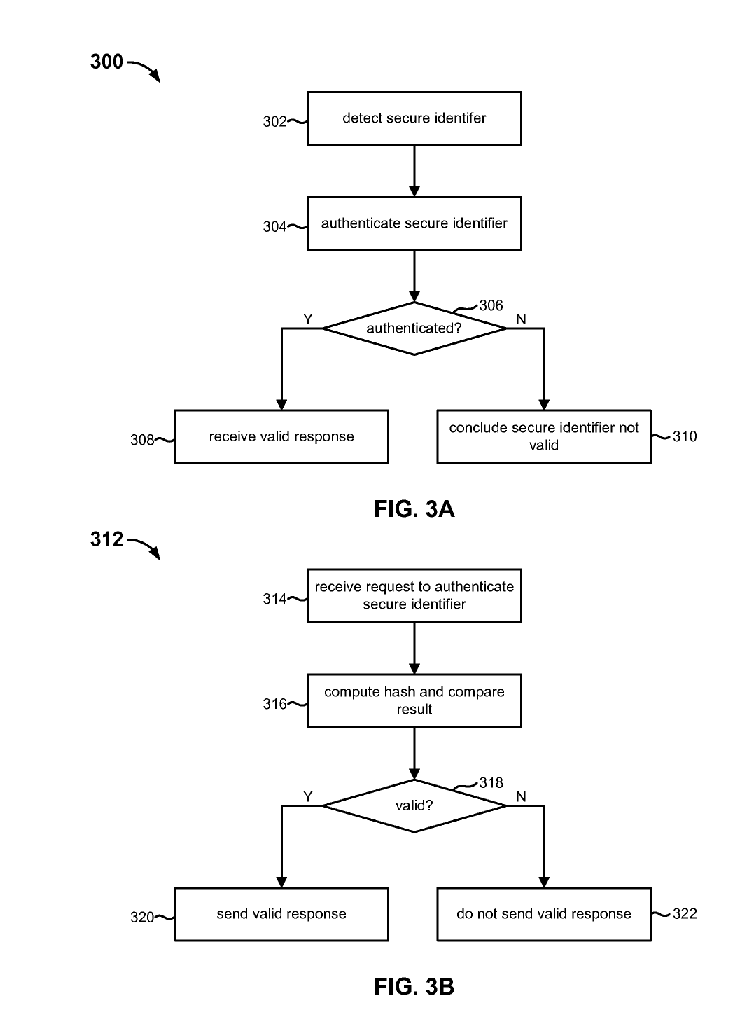

FIGS. 3A-3B are flow charts illustrating embodiments of processes for validating a received secure identifier.

Process 300 of FIG. 3A, for example, may be employed by a mobile handset. At step 302, a secure identifier is detected. At step 304, the secure identifier is authenticated. For example, the secure identifier may be sent to an associated (e.g., shopkick) server for authentication. In alternate embodiments, such processing may be performed on the handset. If the server is unavailable for any reason, the secure identifier may be cached and relayed to the server when it becomes reachable. In order to support such offline walk-ins, each nonce may be valid for a predetermined period of time (e.g., one hour). At step 306, it is determined whether the secure identifier is authenticated. If the secure identifier is authenticated, a valid response is received at step 308 in response to the authentication processing of step 304. If the secure identifier is not authenticated, it is concluded at step 310 that the secure identifier is not valid. That is, a valid response is not received at step 310 in response to the authentication processing of step 304, but instead, for example, no response or an indication that the secure identifier is fraudulent may be received at step 310.

Process 312 of FIG. 3B, for example, may be employed server side, e.g., at a server associated with a mobile application that detects the secure identifier at a handset. At step 314, a request to authenticate a secure identifier is received from a mobile application. At step 316, a hash is computed, and the result is compared with the hash bytes included with the secure identifier. For example, at step 316, an irreversible hash may be computed on the (nonce+store identifier) combination along with the secret key, e.g. using an HMAC, and the result compared with the hash bytes on the secure identifier. At step 318, it is determined if the secure identifier is valid. If it is determined that the secure identifier is valid (e.g., because the hash matches and the nonce in the secure identifier is still valid), a valid response is sent to the client at step 320. If it is determined that the secure identifier is not valid, the request is discarded and/or logged as a fraudulent attempt at step 322, and a valid response is not sent to the client.

An advantage of integrating a Bluetooth module in the transmitter is the ability to interact with the transmitter from a mobile handset, including the ability to update some components of the transmitter code and other parameters from a smartphone.

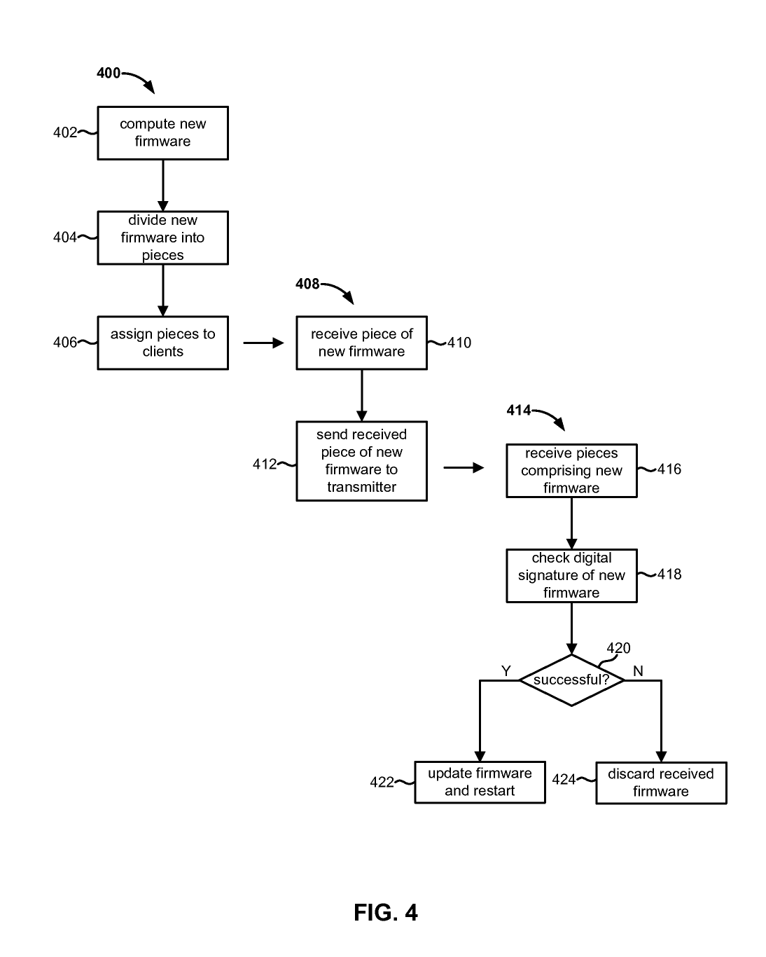

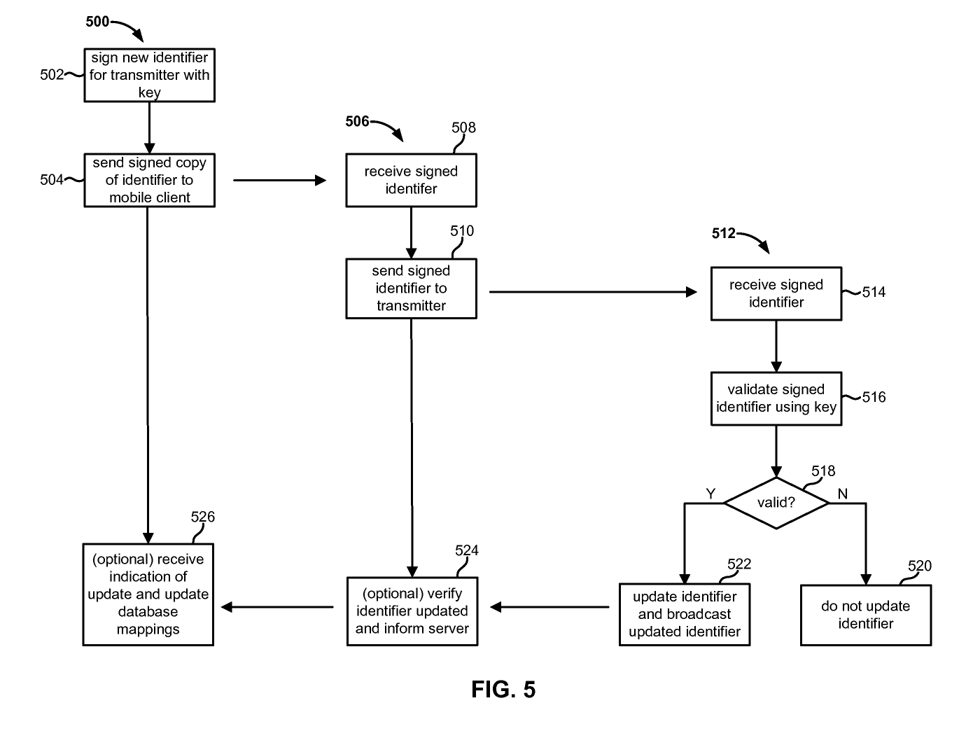

FIGS. 4-5 are flow charts illustrating embodiments of processes for updating the store and/or department identifier(s) assigned to a transmitter.

FIG. 4 comprises flow charts illustrating embodiments of processes associated with updating the firmware on a transmitter, which changes the entire code on the transmitter and reboots the transmitter with the new code. Since the store and/or department identifier(s) are part of the transmitter firmware, they are also updated in the process. Process 400 of FIG. 4 may comprise, for example, a server-side process. At step 402, new firmware is computed. In some cases, the new firmware is computed with a new wave file encoding the transmitter code. Since Bluetooth, and especially BTLE, is suited for small amounts of data transfer, piecewise updating is employed in some embodiments. Accordingly, the entire new firmware is divided into small pieces at step 404. At step 406, the pieces are assigned to clients, e.g., when they walk-in and detect a transmitter and/or depending on their walk-in history. Process 408 of FIG. 4 comprises a client-side process. At step 410, a chunk or piece of the new firmware is received. At step 412, the received piece of new firmware is sent to the transmitter, e.g., so that a small value corresponding to the received piece of new firmware can be updated on the transmitter. Process 414 of FIG. 4 comprises a transmitter-side process. At step 416, pieces comprising the new firmware are received, for example, from one or more clients. At step 418, a digital signature of the new firmware (e.g., an HMAC or another digital signature technique known to those skilled in the art, such as one using an asymmetric encryption such as RSA) is checked. At step 420, it is determined whether the digital signature check is successful. If the digital signature check is successful, the firmware is updated and the transmitter is restarted at step 422. If the digital signature check fails, the received firmware is discarded at step 424, and the existing firmware of the transmitter is not updated.

FIG. 5 comprises flow charts illustrating embodiments of processes associated with updating the transmitter identifier of a transmitter. In some embodiments, the transmitter identifier comprises a writable property (e.g., via Bluetooth GATT protocol) that can be updated by mobile handsets. Process 500 of FIG. 5 comprises a server-side process. At step 502, a new identifier for the transmitter is signed with the key (e.g., using HMAC or another digital signature technique known to those skilled in the art, such as one using an asymmetric encryption such as RSA). At step 504, the signed copy is sent to a mobile client, e.g., when it reports that a particular transmitter has been detected which is deemed by the server to need updating (on demand), or depending on the client's walk-in history or geographic location, e.g., if the client has a history of walking into the venue containing the transmitter or is geographically close to it (prefetching). Process 506 of FIG. 5 comprises a client-side process. At step 508, a signed identifier is received, e.g., at a mobile client from an associated server. At step 510, the signed identifier is sent to the transmitter for updating the identifier value. Process 512 of FIG. 5 comprises a transmitter-side process. At step 514, a signed identifier is received, e.g., at a transmitter from a mobile client. At step 516, the signed identifier is validated using its key in a manner similar to that described above. At step 518, it is determined whether the identifier is valid. If it is determined that the signed identifier is not valid, the transmitter identifier is not updated at step 520. However, if it is determined that the signed identifier is valid, the transmitter identifier is updated (for example, by communicating with the BTLE module via the USART), and the new identifier is broadcasted at step 522. Once the transmitter identifier is updated, a new audio wave file is generated on the transmitter using the new identifier. In some embodiments, process 506 optionally includes step 524 at which the handset verifies that the identifier has been updated and informs the server. In some embodiments, process 500 optionally includes step 526 at which an indication that the identifier has been updated is received at the server from the client and the database mappings of identifiers and venues/departments is accordingly updated at the server.

In some embodiments, Wake-on-Bluetooth is employed for enabling sound based detection. That is, Bluetooth may be used to trigger audio-based detection on mobile handsets. In this technique, Bluetooth scanning, as described above, is used to detect a nearby transmitter, which can then trigger audio detection in an associated application to figure out the exact venue that the user is in. Alternately, the store may be known from the Bluetooth identifier, but presence may not be inferred until a corresponding or compatible audio signal is detected.

In some embodiments, mobile phones are used as Bluetooth relays. Another key mechanism to upgrade existing transmitters without a Bluetooth module (i.e., which only support audio-based signaling) is to turn BTLE enabled handsets into mini ad-hoc transmitters when they are in a store fitted with an audio transmitter. In this scheme, once a handset detects a code via audio signaling, it can then broadcast the same code over its BTLE transmitter and enable other users in the vicinity to take advantage of Bluetooth based detection or wake up as discussed above. This mechanism allows the upgrade of existing infrastructure with BTLE without any additional costs or hardware. It may also be used with initial BTLE detection to extend the range of a BTLE transmitter. In either case, an ad hoc transmitter may be configured to cease operation when a criterion has been reached, such as a threshold period of time since the primary transmitter was detected or detection of a distance traveled (e.g., by accelerometer or GPS or other means on the handset) since the primary transmitter was detected.

In some embodiments, Bluetooth enabled transmitters may be used for fine-grained indoor mapping. That is, the signal propagation properties of Bluetooth may be leveraged to perform fine-grained location mapping including, for example, accurate identification of a user when walking into a store and tracking of the user as the user visits different sections in the store. Such functionality may be achieved, for example, by placing one or more Bluetooth enabled transmitters in every department of a store and recording the signal strength of both audio and Bluetooth signals from all nearby transmitters on a mobile handset. In some such cases, clustering techniques (e.g., triangulation, sorting, etc.) may be employed to narrow the exact location of the mobile handset. Multiple signals from different transmitters can also be used as an authentication mechanism to safeguard against one-off transmitter thefts.

Many applications exist for the combined BTLE and audio-based transmitters described herein. As described, the addition of a BTLE module to the transmitter allows several tasks to be performed efficiently. For example, update of the store and/or department identifier(s) of a transmitter may be remotely accomplished. Moreover, a transmitter may be detected while an associated application is in the background using passive scanning of Bluetooth services as supported in iOS and Android. Such passive Bluetooth detection may trigger multiple actions depending on the situation including, for example, reminding a user to open an application to get rewards, popping up alerts about store and/or department specific offers, and using store specific information from an associated application and the user's profile to show targeted advertisements and reminders. Furthermore, a user may be suggested a store to check out when the user enters a mall. Since Bluetooth signals will bleed out of a store, they can be detected when the user is some distance away and could be used to suggest different stores based on latest promotions and the interests of the particular user.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
generating a secure identifier, wherein the secure identifier comprises a venue identifier; and
configuring a transmitter to broadcast the secure identifier using Bluetooth Low Energy (BTLE);
wherein the secure identifier broadcast by the transmitter is captured by a handset and decoded to infer presence of the handset at a venue identified by the venue identifier.

2. The method of claim 1, wherein the venue identifier comprises one or both of a store identifier and a department identifier.

3. The method of claim 1, wherein the secure identifier includes a nonce.

4. The method of claim 1, wherein generating the secure identifier comprises computing a hash, wherein the hash includes at least one of a nonce value and a secret key.

5. The method of claim 1, further comprising configuring the transmitter to broadcast the secure identifier via an audio channel comprising ultrasonic frequencies.

6. The method of claim 1, further comprising configuring the transmitter to update either or both of the secure identifier and the transmitter firmware based on a directive received via the handset.

7. A method, comprising:
configuring a handset to scan via Bluetooth Low Energy (BTLE) to detect a prescribed service identifier and a corresponding service parameter;
decoding the service parameter, wherein decoding the service parameter includes extracting a venue identifier; and
inferring presence at a venue corresponding to the venue identifier.

8. The method of claim 7, wherein the service identifier comprises a constant universally unique identifier (UUID).

9. The method of claim 7, wherein the service parameter comprises a secure identifier generated by computing a hash including at least one of a nonce value and a secret key.

10. The method of claim 7, wherein the venue identifier comprises one or both of a store identifier and a department identifier.

11. The method of claim 7, wherein the handset is configured to actively scan Bluetooth advertisements.

12. The method of claim 7, wherein the handset is configured to passively scan via BTLE.

13. The method of claim 7, further comprising configuring the handset to receive a secure identifier comprising the venue identifier via an ultrasonic audio channel.

14. The method of claim 7, further comprising authenticating the service parameter.

15. The method of claim 7, further comprising receiving a reward in response to presence at the venue.

16. The method of claim 7, further comprising configuring the handset to update a transmitter that broadcasts the prescribed service identifier and corresponding service parameter.

17. The method of claim 7, further comprising configuring the handset to use BTLE detection to trigger audio-based detection.

18. The method of claim 7, further comprising configuring the handset as a relay to transmit the service identifier and service parameter via BTLE.

19. A system, comprising:
a transceiver configured to scan via Bluetooth Low Energy (BTLE) to detect a prescribed service identifier and a corresponding service parameter; and
a processor configured to decode the service parameter by extracting a venue identifier and infer presence at a venue corresponding to the venue identifier.

20. A computer program product embodied in a non-transitory computer readable storage medium and comprising computer instructions for:
configuring a handset to scan via Bluetooth Low Energy (BTLE) to detect a prescribed service identifier and a corresponding service parameter;
decoding the service parameter, wherein decoding the service parameter includes extracting a venue identifier; and
inferring presence at a venue corresponding to the venue identifier.
